(19) United States
(12) Patent Application Publication
(10) Pub. No.: US 2019/0288512 A1
(43) Pub. Date: Sep. 19, 2019

(54) ELECTRIC POWER SUPPLY SYSTEM AND ELECTRIC POWER SUPPLY CONTROL METHOD

(71) Applicant: SHARP KABUSHIKI KAISHA, Osaka (JP)

(72) Inventor: YOSHIHIDE YASUMURA, Sakai City (JP)

(21) Appl. No.: 16/357,632

(22) Filed: Mar. 19, 2019

(30) Foreign Application Priority Data
Mar. 19, 2018 (JP) 2018-051281

(51) Int. Cl. H02J 3/32; H02J 7/00; G05B 19/042

(52) U.S. Cl. CPC H02J 3/32; H02J 3/383; G05B 19/042; H02J 7/0068

(57) ABSTRACT

Provided are an electric power supply system and an electric power supply control method where a power storage device can discharge to a charge level below a predetermined remaining stored charge level in response to an electric power supply request received over a public communications network. The electric power supply system communicates with a public communications network and includes a storage battery configured to store electric power. The system controls the storage battery to maintain a predetermined first remaining stored charge level and controls, in response to an electric power supply request received over the public communications network, the storage battery to discharge in an electric power supply request period to a level not below a second remaining stored charge level that is below the first remaining stored charge level.

### FIELD OF THE INVENTION

The present invention relates to electric power supply systems including a power storage device and electric power supply control methods involving use of a power storage device.

### BACKGROUND OF THE INVENTION

Recent years have seen increasingly widespread use of electric power supply systems equipped with a power storage device, for example, for storing relatively inexpensive late-night electric power and storing solar-generated excess electric power.

These electric power supply systems are designed by paying special attention to the remaining electric power of the power storage device that is available for use in an emergency such as a power failure in the commercial power grid that may occur when there is not sufficient solar-generated electric power.

The electric power supply system disclosed in Patent Document 1, as an example, is designed to maintain a preferred amount of electric power in storage to keep a minimum remaining stored charge level of a power storage device in case the system cannot be fed with electric power from solar cells and a commercial power grid.

Meanwhile, VPPs (virtual power plants) are of interest due to recent deregulation of electric power. A VPP collectively controls power generation, storage, and saving resources (e.g., sunlight, storage batteries, and demand responses (DRs)) distributed across several geographical areas so that the resources can operate as if they were a single power plant.

By leveraging a VPP, electric power consumers, who have so far only used electric power, can become electric power suppliers at times. Specifically, an electric power consumer can reduce his/her power consumption by power saving and in-house power generation and sell the difference to a utility company or on the market as if he/she had generated the power. These activities are done through, for example, demand responses (DRs).

A demand response (DR) is such a change in the power consumption pattern of an electric power consumer as to restrict power consumption in accordance with electricity pricing or incentive payment when the wholesale market price is high or when the system reliability is low. For example, in response to a request or instruction (demand response (DR)) from a utility company or system operating entity to decrease power consumption, electric power consumers supply the electric power that they have stored in storage batteries to the utility company or system operating entity.

### CITATION LIST

### Patent Documents

Patent Document 1: Japanese Unexamined Patent Application Publication, Tokukai, No. 2014-121153 (Publication Date: Jun. 30, 2014)

### SUMMARY OF THE INVENTION

### Problems to be Solved by the Invention

The conventional electric power supply system described above has the following problems. If the storage battery has a remaining electric power that is as small as a minimum remaining stored charge level when an instruction (demand response (DR)) to decrease consumption is received, the system cannot use the electric power stored in the storage battery in spite that the storage battery is still charged up to the minimum remaining stored charge level.

The present invention, in an aspect thereof, has been made in view of this conventional problem and has an object to provide an electric power supply system in which a power storage device discharges to a level below a predetermined remaining stored charge level in response to an electric power supply request received over a public communications network.

### Solution to the Problems

To address the problem, the present invention, in an aspect thereof, is directed to an electric power supply system configured to communicate with a public communications network, the system including a power storage device configured to store electric power, the system being further configured to: control the power storage device to maintain a predetermined first remaining stored charge level; and control, in response to an electric power supply request received over the public communications network, the power storage device to discharge electric power in an electric power supply request period to a level not below a second remaining stored charge level that is below the first remaining stored charge level.

To address the problem, the present invention, in an aspect thereof, is directed to a method of controlling electric power supply, the method including: controlling a power storage device to maintain a predetermined first remaining stored charge level; and controlling, in response to an electric power supply request received over a public communications network, the power storage device to discharge electric power in an electric power supply request period to a level not below a second remaining stored charge level that is below the first remaining stored charge level.

### Advantageous Effects of the Invention

The present invention, in an aspect thereof, has the advantage of providing an electric power supply system and an electric power supply control method where a power storage device can discharge to a charge level below a predetermined remaining stored charge level in response to an electric power supply request received over a public communications network.

### BRIEF DESCRIPTION OF DRAWINGS

FIG. 1 is a graph representing exemplary changes over a 24-hour period of the charge level of a storage battery in an electric power supply system in accordance with Embodiment 1 of the present invention.

FIG. 2 is a block diagram of a configuration of the electric power supply system.

FIG. 3A is a diagram representing pricing that changes with the period of the day as an electricity tariff-based demand response (DR) in an electric power supply system. FIG. 3B is a diagram representing pricing that changes during peak hours as an electricity tariff-based demand response (DR) in the electric power supply system. FIG. 3C is a diagram representing peak-day pricing as an electricity tariff-based demand response (DR) in the electric power supply system. FIG. 3D is a diagram representing real-time pricing as an electricity tariff-based demand response (DR) in the electric power supply system.

FIG. 4A is a diagram representing an incentive-based demand response (DR) where a request is issued to disconnect and/or reduce a load in an electric power supply system. FIG. 4B is a diagram representing an incentive-based demand response (DR) where the supply and demand balance is adjusted in the market.

FIG. 5 is a diagram representing, in the electric power supply system: a series of instructions for reduction of demand; the contents of these demand-reducing instructions from an aggregator to an electric power consumer in accordance with the level of the demand-reducing instructions from a power generation company/power grid operator; the contents of the instructions transmitted to the electric power consumer's home of the electric power consumer and to an out-of-home electric power consumer of the electric power consumer: and reactions of the electric power consumer's home.

FIG. 6 is a block diagram of a configuration of an electric power supply system in accordance with Embodiment 2 of the present invention.

### DESCRIPTION OF EMBODIMENTS

### Embodiment 1

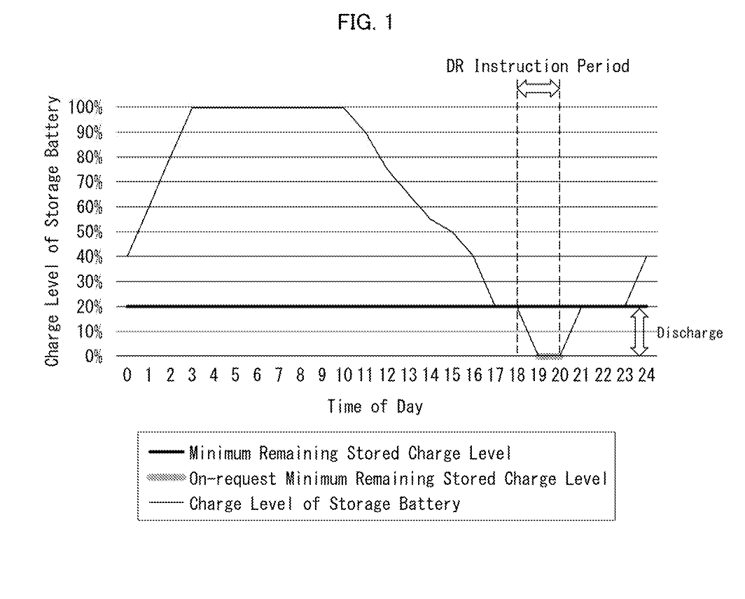

The following will describe an embodiment of the present invention in reference to FIGS. 1 to 5.

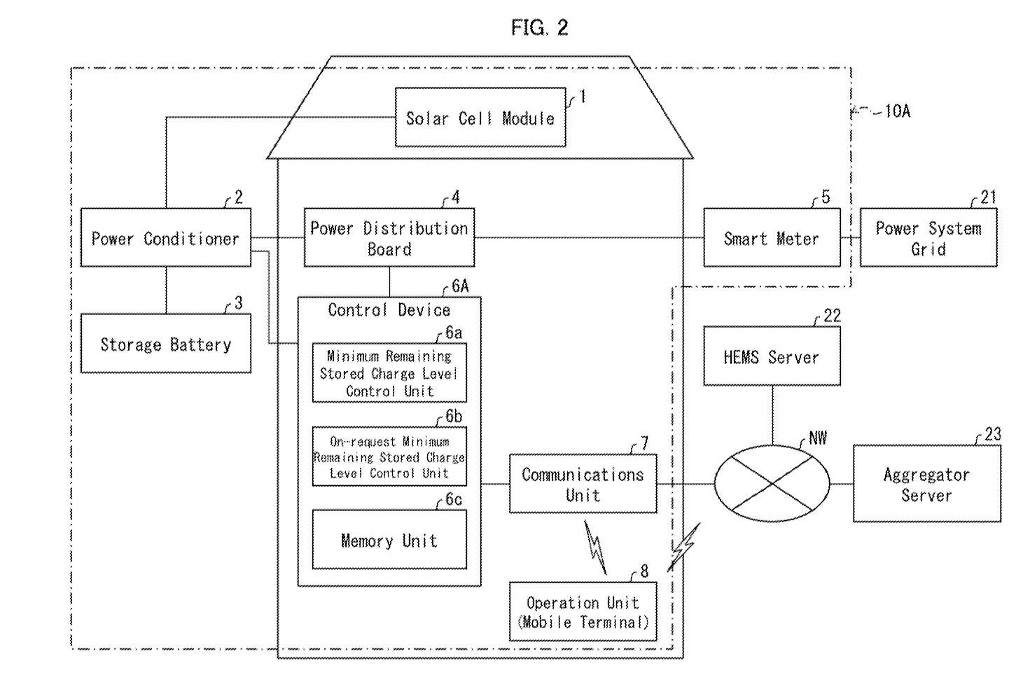

A configuration of an electric power supply system 10A in accordance with the present embodiment will be described in reference to FIG. 2. FIG. 2 is a block diagram of a configuration of the electric power supply system 10A in accordance with the present embodiment. The electric power supply system 10A is shown in FIG. 2 as being installed in a detached house as an example, but may be installed anywhere. FIG. 2 also shows a power system grid 21, an HEMS server 22, and an aggregator server 23, as well as the electric power supply system 10A.

In the electric power supply system 10A in accordance with the present embodiment, the electric power consumer has a renewable energy-based power generation system. More particularly, the electric power consumer has a power generation system that generates electric power from solar energy for storage in a power storage device. The electric power supply system 10A includes, in addition to structures related to electric power generation, a structure that presents a power generation status and other information to the electric power consumer and a structure that externally obtains information necessary for the operation of the electric power supply system 10A.

The electric power supply system 10A in accordance with the present embodiment, as shown in FIG. 2, includes a solar cell module 1, a power conditioner 2, a storage battery 3, a power distribution board 4, a smart meter 5, a control device 6A, a communications unit 7, and an operation unit 8.

The solar cell module 1 converts the sun's light energy to electrical energy.

The power conditioner 2 converts generated electric power so that a load can use it. Specifically, the power conditioner 2, for example, converts the DC output of the solar cell module 1 to AC.

The storage battery 3 stores electrical energy that is either generated by the solar cell module 1 or supplied from the power system grid 21.

The power conditioner 2 and the storage battery 3 are installed outdoors in the present embodiment. The power conditioner 2 and the storage battery 3 are, however, not necessarily installed outdoors and may be installed indoors. The electric power supply system 10A may include an additional power generation device (not shown) such as fuel cells that generates electric power from fuel gas. The amount of the electric power generated by the additional power generation device may be, for example, detected by a sensor, so that the control device 6A, which will be described later in detail, can acquire the detection value. This configuration enables the electric power consumer to be informed of the status of the electric power supply system 10A that is inclusive of the amount of the electric power generated by the additional power generation device. There may be provided a plurality of power conditioners 2, in which case these power conditioners 2 may be controlled either by a single control device 6A or by a plurality of control devices 6A.

The power distribution board 4 is an electrical junction box that collects electric power from the power system grid 21 via the smart meter 5 and also from the solar cell module 1 and the storage battery 3 and that distributes electric power to indoor electrical appliances (not shown).

The smart meter 5 is a digital watt-hour meter that measures electric energy consumption by the electric power consumer (supply and demand contractee) in order to send measurements to a power generation company/power grid operator 31 (detailed later). The smart meter 5 is installed outside the electric power consumer's home in the present embodiment. Alternatively, the smart meter 5 may be installed inside the electric power consumer's home to prevent non-contractees from tampering with the smart meter 5.

The control device 6A obtains electric power information related to electric power generation by the electric power supply system 10A and controls the operation of the power conditioner 2 in accordance with the electric power information. Examples of the electric power information include information as to whether or not there is a commercial demand to buy electric power, information on the power generated by the solar cell module 1, and information on the electric power either charged or discharged by the storage battery 3. The presence/absence of a commercial demand to buy electric power and the amount of electric energy being bought can be determined from output values of a sensor connected to an electric power line that links the smart meter 5 to the power system grid 21. The information on the power generated by the solar cell module 1 and information on the electric power either charged or discharged by the storage battery 3 can be obtained via the power conditioner 2. Furthermore, since the storage battery 3 is connected to the power conditioner 2, the control device 6A is capable of controlling, for example, switching the storage battery 3 between charging and discharging via the power conditioner 2.

The control device 6A also manages information on the electric power supply system 10A and handles communications with the outside. Specifically, the control device 6A transmits the obtained electric power information to an information managing server (not shown) of the power generation company/power grid operator 31. In addition, the control device 6A obtains the information detailed above that is needed for its operation from the information managing server of the power generation company/power grid operator 31. The structure of the control device 6A in accordance with the present embodiment will be described later in detail.

The communications unit 7 provides a local area network in the home of the electric power consumer and also connects to a network NW to connect the local area network to the external network NW (e.g., the Internet) in a communicable manner. Various loads that consume electric power such as air conditioners (including air cleaners), television sets, and electrical cooking appliances (none shown) may be connected to the local area network in the home. This configuration enables the electric power consumer to check the operation status of various apparatus and to control the operation of various apparatus, via the local area network. A data transmitter may also be connected that transmits the detection value of electric power or current delivered to the apparatus or sensing information such as room temperature, in which case the power consumption by various home apparatus can be presented to the electric power consumer.

The operation unit 8 includes a mobile terminal that has communications and information output capabilities. The electric power consumer, who owns the electric power supply system 10A, can on the operation unit 8 check the power generation status of the electric power supply system 10A and set the minimum remaining stored charge level and the on-request minimum remaining stored charge level to proper values.

The operation unit 8 preferably includes a mobile terminal such as a smartphone or a tablet terminal. Alternatively, the operation unit 8 may include a personal computer or like stationary terminal device. The operation unit 8 communicates over the local area network and the external network NW.

Outside the electric power supply system 10A in accordance with the present embodiment are there provided the power system grid 21 and, over the network NW, the HEMS (home energy management system) server 22 and the aggregator server 23.

The power system grid 21, built, for example, by a power generation company/power grid operator, is an electric power network via which electric power is supplied at a price (sold) to electric power consuming facilities. Additionally, the electric power generated by the electric power supply system 10A may be supplied (exported) to the power system grid 21 to sell the electric power to the power generation company/power grid operator.

The HEMS server 22 obtains and manages electric power information related to the electric power supply system 10A. The electric power consumer can access the HEMS server 22 via the operation unit 8 to check, for example, a power generation status. Although FIG. 2 shows only one HEMS server 22, the electric power supply system 10A can access a server other than the HEMS server 22. As an example, the control device 6A accesses an information managing server that is provided, for example, by the power generation company/power grid operator 31, who is the operator and manager of the power system grid 21, in order to obtain information necessary for the operation of the control device 6A. Examples of this information include schedule information representing a scheduled control of the output of the electric power supply system 10A and time information used to adjust a clock for the electric power supply system 10A.

The aggregator server 23 receives, from the power generation company/power grid operator 31 or a parent aggregator (detailed later), a demand response (DR) for a reduction in electric power demand and transmits such an instruction to the electric power consumer via the network NW as to reduce demand and/or the minimum remaining stored charge level.

Now, the characteristic structure of the control device 6A in the electric power supply system 10A in accordance with the present embodiment will be described in reference to FIG. 2.

The control device 6A in accordance with the present embodiment, as shown in FIG. 2, includes a minimum remaining stored charge level control unit 6a, an on-request minimum remaining stored charge level control unit 6b, and a memory unit 6c. The control device 6A may include an operation unit (not shown) so that the electric power consumer can manually operate the control device 6A directly without relying on the operation unit 8 built around a mobile terminal when the electric power consumer is at home.

The minimum remaining stored charge level control unit 6a controls the storage battery 3 to maintain a predetermined minimum remaining stored charge level KE. In other words, in the electric power supply system 10A in accordance with in the present embodiment, one can specify a minimum remaining stored charge level KE for the electric power being stored in the storage battery 3. The minimum remaining stored charge level control unit 6a then controls the electric discharge from the storage battery 3 in such a manner as to maintain the minimum remaining stored charge level KE in the storage battery 3 during normal operation. The electric power stored in the storage battery 3 for maintaining the minimum remaining stored charge level KE is available for use, for example, in an emergency such as a power failure in the power system grid 21 that may occur when the solar cell module 1 is not generating sufficient power.

The minimum remaining stored charge level KE for the storage battery 3 may be set to any value, for example, 20% or 30% the full charge. The value setting is recorded in advance in the memory unit 6c. The electric power consumer can change, when necessary, the value setting of the minimum remaining stored charge level KE stored in the memory unit 6c via the operation unit 8.

In response to an electric power supply request received from the aggregator server 23 of an aggregator 32 over the network NW (public communications network), the on-request minimum remaining stored charge level control unit 6b in accordance with the present embodiment controls the storage battery 3 to discharge in an electric power supply request period to a level not below an on-request minimum remaining stored charge level DRKE (second remaining stored charge level) that is below the minimum remaining stored charge level KE (first remaining stored charge level). The electric power consumer can set the on-request minimum remaining stored charge level DRKE of the storage battery 3 to any value, for example, to 0%, 5%, or 10% the full charge. The value setting is stored in advance in the memory unit 6c. In the present embodiment, even if the on-request minimum remaining stored charge level DRKE is, for example, 0% the full charge, the charge level is actually prevented from falling, for example, below 5%. Therefore, the storage battery 3 can continue to discharge even after the apparent charge level has reached 0%. It is preferable as described here that the on-request minimum remaining stored charge level DRKE not be set to the absolute 0% of the full charge, but set to such a value, in case of malfunction, that the storage battery 3 can actually continuously discharge a little more even after the apparent charge level has reached 0%.

The memory unit 6c stores the value setting of the minimum remaining stored charge level KE and the value setting of the on-request minimum remaining stored charge level DRKE. The electric power consumer can, when necessary, change the value setting of the minimum remaining stored charge level KE and the value setting of the on-request minimum remaining stored charge level DRKE stored in the memory unit 6c through the operation unit 8.

In other words, if, for example, a demand response (DR) to decrease consumption is received as an electric power supply request transmitted over the network NW (public communications network), it is preferable to supply electric power by discharging the storage battery 3 to satisfy such a request. However, if the storage battery 3 has a remaining electric power that is as small as the predetermined minimum remaining stored charge level KE in the electric power supply request period, the electric power supply system 10A cannot use the electric power stored in the storage battery 3 in spite that the storage battery 3 is still charged up to the minimum remaining stored charge level KE. Meanwhile, even if the storage battery 3 discharges to a level below the predetermined minimum remaining stored charge level KE to satisfy an electric power supply request transmitted over the network NW (public communications network), the storage battery 3 rarely needs to discharge for home use at the same time.

Accordingly, in the electric power supply system 10A in accordance with in the present embodiment, the on-request minimum remaining stored charge level control unit 6b in the control device 6A, upon receiving an electric power supply request transmitted over the network NW (public communications network), controls the storage battery 3 to discharge in an electric power supply request period to a level not below the on-request minimum remaining stored charge level DRKE, which is below the predetermined minimum remaining stored charge level KE.

This configuration enables electric power supply by the storage battery 3 discharging in an electric power supply request period to a level that is in a range of from the minimum remaining stored charge level KE to the on-request minimum remaining stored charge level DRKE. Hence, the storage battery 3 in the electric power supply system 10A can discharge to a level below the predetermined minimum remaining stored charge level KE in response to an electric power supply request received over the network NW.

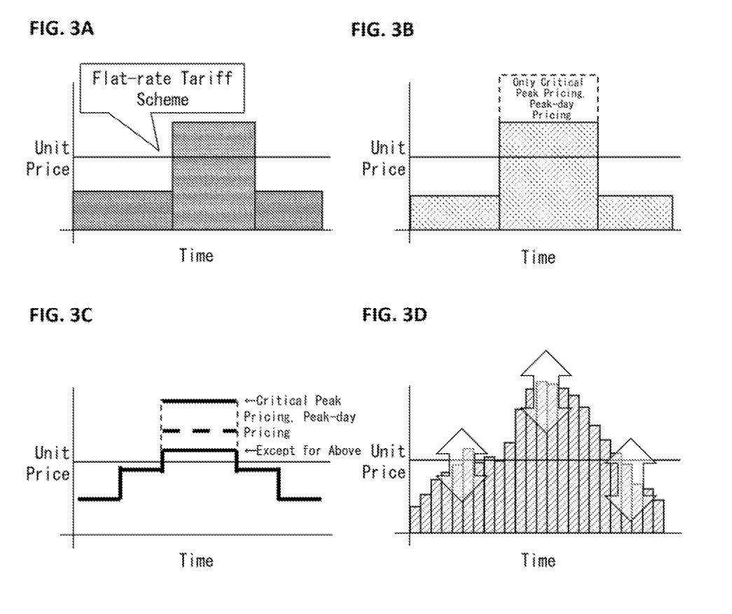

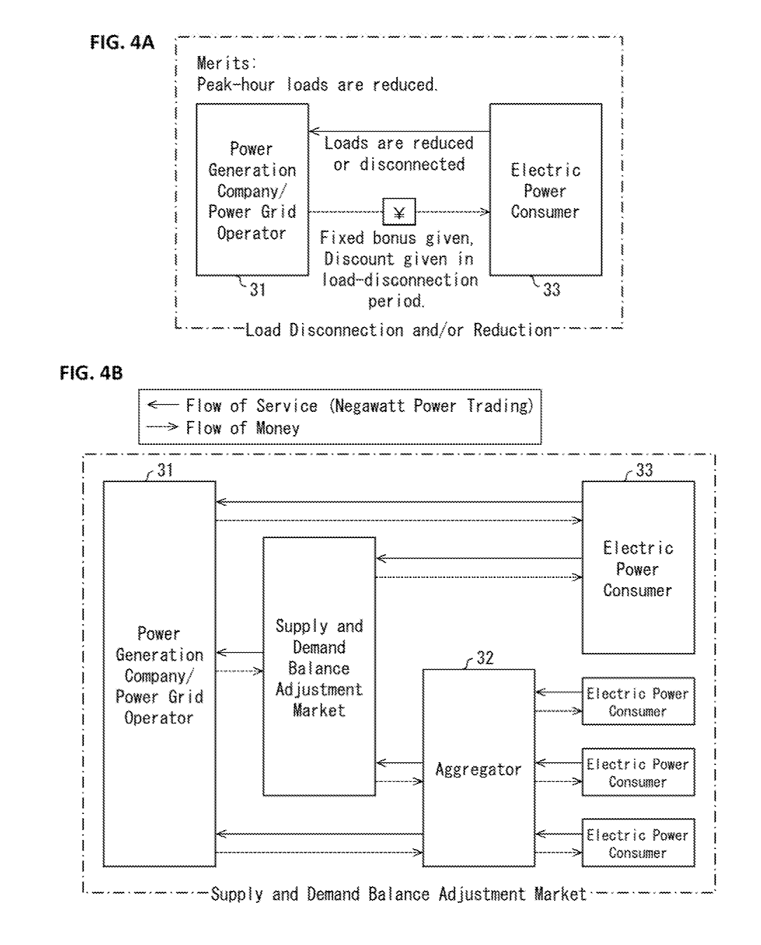

A demand response (DR) that contains an electric power supply request transmitted over a network NW in a VPP (virtual power plant) will now be described in detail in reference to FIG. 3A, FIG. 3B, FIG. 3C, and FIG. 3D and FIG. 4A and FIG. 4B. FIG. 3A is a diagram representing pricing that changes with the period of the day as an electricity tariff-based demand response (DR) in the electric power supply system 10A. FIG. 3B is a diagram representing pricing that changes during peak hours as an electricity tariff-based demand response (DR). FIG. 3C is a diagram representing peak-day pricing as an electricity tariff-based demand response (DR). FIG. 3D is a diagram representing real-time pricing as an electricity tariff-based demand response (DR). FIG. 4A is a diagram representing an incentive-based demand response (DR) where a request is issued to disconnect and/or reduce a load in an electric power supply system. FIG. 4B is a diagram representing an incentive-based demand response (DR) where the supply and demand balance is adjusted in the market.

First of all, a VPP (virtual power plant) collectively controls power generation, storage, and saving resources (e.g., sunlight, storage batteries, and demand responses (DRs)) distributed across several geographical areas so that the resources can operate as if they were a single power plant.

A demand response (DR) is such a change in the power consumption pattern of an electric power consumer as to restrict power consumption in accordance with electricity pricing or incentive payment when the wholesale market price is high or when the system reliability is low.

Demand responses (DR) are roughly classified into those based on an electricity tariff such as pricing that changes with the period of the day and those based on an incentive such as a supply and demand balance adjustment contract.

In the electricity tariff-based DR, the power generation company/power grid operator determines pricing that changes with the period of the day (or with time) so that the electric power consumer can on their own initiative reduce demand at a time of heavy load when a relatively expensive tariff is set and increase demand at a time of light load when a relatively inexpensive tariff is set.

Typical examples of electricity tariff-based DRs include pricing that changes with the period of the day (time-of-use pricing or “TOU”), pricing that changes during peak hours (critical peak pricing or “CPP”), peak-day pricing (“PDP”), and real-time pricing (“RTP”).

Pricing that changes with the period of the day (TOU) increases or decreases electricity tariff depending on the period of the day as shown in FIG. 3A. A well-known example is a late-night electricity tariff where the unit price is lowered when the overall demand level is the lowest.

As shown in FIG. 3B, peak-time pricing (CPP) is the same as TOU at normal time and applies a higher unit price under specific conditions (e.g., in an emergency or when the wholesale electric power price is high).

As shown in FIG. 3C, peak-day pricing (PDP), being one of the systems that are derived from TOU, sets apart approximately 10 days a year as peak days when there occurs a high electric power demand and applies a higher tariff at a specific period of the peak days (primarily during the daytime) and a fixed tariff on non-peak days.

Real-time pricing (RTP), as shown in FIG. 3D, reflects a wholesale electric power market price (preceding-day market or real-time market) that changes with time.

Meanwhile, in incentive-based DRs such as supply and demand balance adjustment contract-based DRs, the power generation company/power grid operator signs a contract with the electric power consumer in order to reduce or disconnect loads or to request the consumer to reduce or disconnect loads when the wholesale electric power price increases or when electric power supply is not sufficiently higher than demand.

An exemplary incentive-based DR is shown in FIG. 4A where the power generation company/power grid operator 31 requests an electric power consumer 33 to reduce or disconnect loads when the wholesale electric power price increases or electric power supply is not sufficiently higher than demand. The power generation company/power grid operator 31 promises to discount electricity tariff as a reward (fixed bonus or incentive) during the time when loads are reduced or disconnected. The electric power consumer 33 responds to this request by reducing or disconnecting loads. Hence, the power generation company/power grid operator 31 can reduce electric power loads during peak hours, whereas the electric power consumer 33 can receive a fixed bonus or incentive.

Another exemplary incentive-based DR is negawatt power (saved power) trading shown in FIG. 4B. Negawatt power trading regards the demand reduced by the electric power consumer 33 as a supply available for commercial trading, for example, in the market. In negawatt power trading, for example, the aggregator 32 collectively trades the amounts of adjustment of a plurality of electric power consumers 33. The aggregator 32 is, for example, a marketer, broker, local public organization, or non-profit organization that coordinate the electric power demands of the electric power consumers 33 to provide efficient energy management services.

The electric power consumer 33 can as described here sell the electric power stored in the storage battery 3 in response to a request (demand response (DR)) to decrease consumption from the power generation company/power grid operator 31 or from the aggregator 32 who mediates between the power generation company/power grid operator 31 and the electric power consumer 33 and can also receive an incentive in accordance with the request. For these reasons, the electric power consumer 33 preferably sells the electric power stored in the storage battery 3.

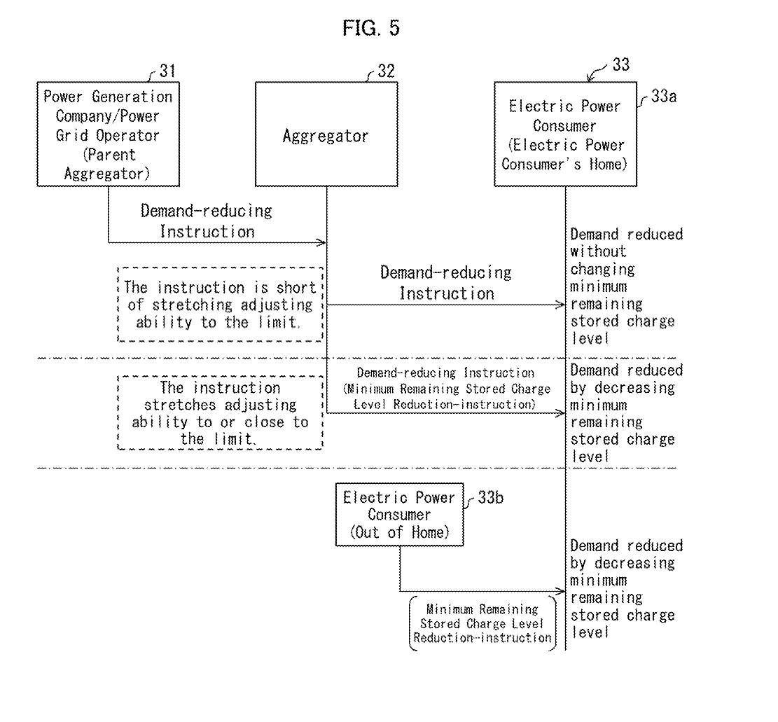

Referring to FIG. 5, a description is now given of the reactions of the aggregator 32 and the electric power consumer 33 in response to a request (demand response (DR)) from the power generation company/power grid operator 31 to decrease consumption. FIG. 5 is a diagram representing, in the electric power supply system 10A in accordance with the present embodiment: a series of instructions for reduction of demand; the contents of these demand-reducing instructions from the aggregator 32 to the electric power consumer 33 in accordance with the level of the demand-reducing instructions from the power generation company/power grid operator 31; the contents of the instructions transmitted to an electric power consumer's home 33a of the electric power consumer 33 and to an out-of-home electric power consumer 33b of the electric power consumer 33; and reactions of the electric power consumer's home 33a.

Referring to FIG. 5, the aggregator 32 installs a centralized electric power management system on their own to serve as an intermediary for energy management support service (that collects data on electric power consumption to support energy saving), electric power trading, electric power delivery service, and other services. One of the services offered by the aggregator 32 is demand response (DR). In this mechanism, the power generation company/power grid operator 31 pays a reward to the aggregator 32 for the negawatts (amount of saved electric power) generated through the DR service, whereas the electric power consumer 33 receives, for example, a financial incentive from the aggregator 32.

Still referring to FIG. 5, the power generation company/power grid operator 31 issues a demand response (DR) request to decrease consumption to the aggregator 32. It may be a parent aggregator of that aggregator 32 that issues a demand response (DR) request to decrease consumption.

This demand response (DR) for reduced consumption comes in two types: the demand-reducing instruction is well short of stretching adjusting ability to the limit in one type and is so strenuous as to stretch adjusting ability to or close to the limit in the other type.

In the case of the former type of demand-reducing instruction, the aggregator 32 sends the demand-reducing instruction to the electric power consumer 33. The electric power consumer's home 33a, which is the electric power consumer 33, then reduces demand without changing the minimum remaining stored charge level KE.

On the other hand, in the case of the latter type of demand-reducing instruction, the aggregator 32 specifies an on-request minimum remaining stored charge level DRKE below the minimum remaining stored charge level KE for the electric power consumer's home 33a, which is the electric power consumer 33, to reduce demand. If the electric power consumer 33 is out of home (i.e., in the case of the out-of-home electric power consumer 33b), the out-of-home electric power consumer 33b can specify an on-request minimum remaining stored charge level DRKE that is below the minimum remaining stored charge level KE on the operation unit 8 either voluntarily or in response to the arrival of the instruction at the operation unit 8 (mobile terminal).

The aggregator 32 has adjusting ability specified in this manner. If the demand-reducing instruction from the power generation company/power grid operator 31 or the parent aggregator is so strenuous as to stretch the adjusting ability to or close to the limit, the aggregator 32 sends, in addition to a demand-reducing instruction, an instruction to reduce the minimum remaining charge level setting to the on-request minimum remaining stored charge level DRKE, which is below the minimum remaining stored charge level KE, to the electric power consumer's home 33a. The electric power consumer's home 33a is configured to reduce demand by lowering the minimum remaining stored charge level KE to the on-request minimum remaining stored charge level DRKE. Additionally, if the out-of-home electric power consumer 33b where the electric power consumer 33 is out of home wants to change the minimum remaining charge level setting to the on-request minimum remaining stored charge level DRKE, which is below the minimum remaining stored charge level KE, from outside because, for example, the out-of-home electric power consumer 33b would not have any particular trouble in a power failure in the electric power consumer's home 33a, the out-of-home electric power consumer 33b sends an instruction to lower the minimum remaining stored charge level KE for the electric power consumer's home 33a to the on-request minimum remaining stored charge level DRKE, for example, via the HEMS server 22 by manually operating the operation unit 8 (e.g., smartphone) outside the home.

As shown in FIG. 1, the on-request minimum remaining stored charge level DRKE, which is below the minimum remaining stored charge level KE, is specified, and the storage battery 3 is discharged, all in a demand response (DR) instruction period. In other words, the demand-reducing instruction by means of a demand response (DR) is issued prior to a demand response (DR) instruction period.

FIG. 1 shows a specific demand response (DR) instruction period of 18:00 to 20:00. In the present embodiment, as an example, the minimum remaining stored charge level KE is set to 20% the full charge of the storage battery 3, whereas the on-request minimum remaining stored charge level DRKE is set to 0% the full charge of the storage battery 3. Therefore, the storage battery 3 can discharge to a level in the range of from the minimum remaining stored charge level KE (=20%) to the on-request minimum remaining stored charge level DRKE (=0%), to sell the discharged electric power to the aggregator 32.

As described here, the storage battery 3 is preferably charged to maintain the minimum remaining stored charge level KE after the demand response (DR) instruction period is over, in which case the storage battery 3 may be controlled to be charged in a late-night electricity tariff period. This control is done by the control device 6A. This configuration enables inexpensive charging of the storage battery 3 with late-night electric power.

As described so far, the electric power supply system 10A in accordance with the present embodiment includes: the communications unit 7 which communicates with the network NW which is a public communications network; the storage battery 3 which is a power storage device for storing electric power; and the on-request minimum remaining stored charge level DRKE for the control device 6A controlling the storage battery 3 to maintain the minimum remaining stored charge level KE (predetermined first remaining stored charge level) and also controlling, in response to an electric power supply request received over the network NW, the storage battery 3 to discharge electric power in an electric power supply request period to a level not below the on-request minimum remaining stored charge level DRKE (second remaining stored charge level), which is below the minimum remaining stored charge level KE.

A electric power supply control method in accordance with the present embodiment includes: controlling the storage battery 3 to maintain the predetermined minimum remaining stored charge level KE; and controlling, in response to an electric power supply request received over the network NW, the storage battery 3 to discharge electric power in an electric power supply request period to a level not below the on-request minimum remaining stored charge level DRKE, which is below the minimum remaining stored charge level KE.

Either of these configurations enables electric power discharge for supply in an electric power supply request period in a range of from the minimum remaining stored charge level KE to the on-request minimum remaining stored charge level DRKE. Therefore, in the electric power supply system 10A and the electric power supply control method, the storage battery 3 can discharge to a level below the predetermined minimum remaining stored charge level KE in response to an electric power supply request received over the network NW.

The electric power supply system 10A in accordance with the present embodiment further includes: the memory unit 6c for storing a value for the minimum remaining stored charge level KE and a value for the on-request minimum remaining stored charge level DRKE; and the operation unit 8 for changing the values stored in the memory unit 6c for the minimum remaining stored charge level KE and the on-request minimum remaining stored charge level DRKE.

This configuration enables the values of the minimum remaining stored charge level KE and the on-request minimum remaining stored charge level DRKE to be readily changed via the operation unit 8 in accordance with a situation.

In the electric power supply system 10A in accordance with the present embodiment, the manual operation of the operation unit 8 can be changed via the communications unit 7 on a mobile terminal, such as a smartphone, that is an external device. This configuration enables the values of the minimum remaining stored charge level KE and the on-request minimum remaining stored charge level DRKE to be readily changed through external communications.

In the electric power supply system 10A in accordance with the present embodiment, the control device 6A controls the storage battery 3 to maintain the minimum remaining stored charge level KE once the electric power supply request period is over. Specifically, if the remaining charge level of the storage battery 3 when the electric power supply request period is over is below the minimum remaining stored charge level KE, the control device 6A starts to charge the storage battery 3. Once the storage battery 3 is charged to the minimum remaining stored charge level KE, the control device 6A controls the storage battery 3 to maintain the minimum remaining stored charge level KE. This configuration can return the minimum remaining stored charge level KE of the storage battery 3 to a normal state. If the remaining charge level of the storage battery 3 when the electric power supply request period is over is greater than or equal to the minimum remaining stored charge level KE, the control device 6A controls the storage battery 3 to discharge while maintaining the minimum remaining stored charge level KE.

In addition, in the electric power supply system 10A in accordance with the present embodiment, the control device 6A controls the storage battery 3 to charge back to the minimum remaining stored charge level KE in a late-night electricity tariff period once the electric power supply request period is over. Even if the remaining charge level of the storage battery 3 when the electric power supply request period is over is below the minimum remaining stored charge level KE, the control device 6A does not immediately starts to charge the storage battery 3, but waits until the electricity tariff becomes relatively inexpensive before starting to charge the storage battery 3. This configuration enables inexpensive charging of the storage battery 3 with late-night electric power. The control device 6A performs no discharge control on the storage battery 3 until the control device 6A starts to charge the storage battery 3. Once the storage battery 3 is charged to the minimum remaining stored charge level KE, the control device 6A controls the storage battery 3 to maintain the minimum remaining stored charge level KE.

### Embodiment 2

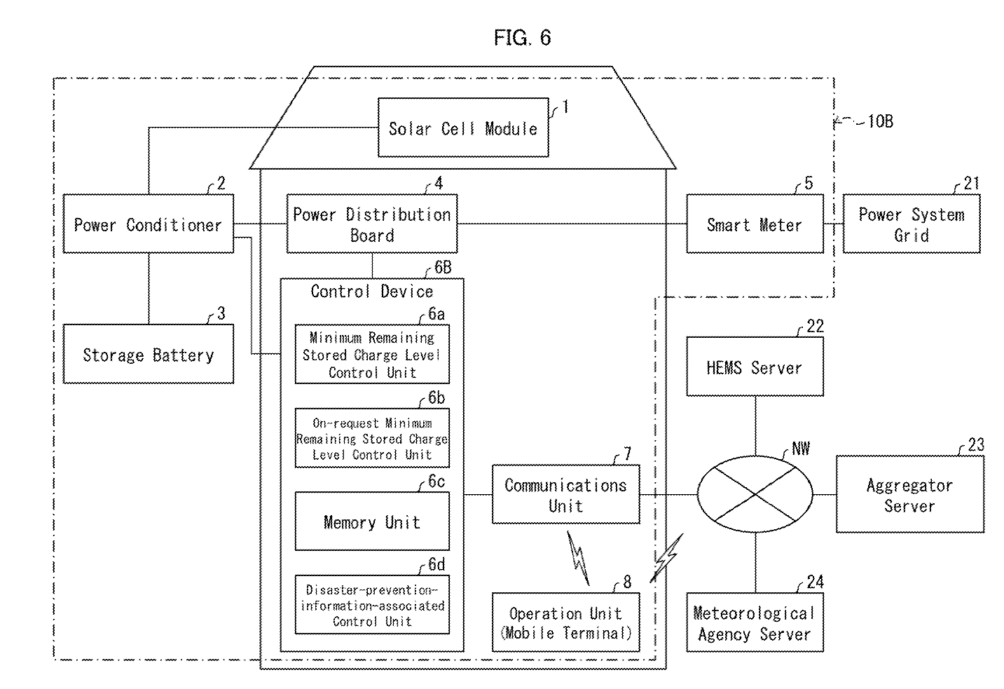

The following will describe another embodiment of the present invention in reference to FIG. 6. The present embodiment is the same as Embodiment 1 described above unless otherwise mentioned. For convenience of description, members of the present embodiment that have the same function as members shown in drawings for Embodiment 1 are indicated by the same reference numerals, and description thereof is omitted.

An electric power supply system 10B in accordance with the present embodiment, as shown in FIG. 6, differs from the electric power supply system 10A in accordance with Embodiment 1 in that in the former, the network NW is connected additionally to a Meteorological Agency server 24 that issues weather warnings.

A configuration of the electric power supply system 10B in accordance with the present embodiment will be described in reference to FIG. 6. FIG. 6 is a block diagram of a configuration of the electric power supply system 10B in accordance with the present embodiment.

In the electric power supply system 10B in accordance with the present embodiment, the network NW is connected to the Meteorological Agency server 24 that issues weather warnings as shown in FIG. 6. A control device 6B includes a disaster-prevention-information-associated control unit 6d that controls electric power supply in association with a warning received by the electric power supply system 10B from the Meteorological Agency server 24 over the network NW.

A description is now given of the control performed by the disaster-prevention-information-associated control unit 6d in the control device 6B in accordance with the present embodiment.

In the present embodiment, the control device 6B controls the storage battery 3 to discharge in an electric power supply request period to a level not below the on-request minimum remaining stored charge level DRKE, which is below the minimum remaining stored charge level KE, in response to an electric power supply request received from the aggregator 32 over the network NW as mentioned above.

However, disaster-prevention warnings are often issued in an emergency when electric power may be needed, for example, in case of a power failure. It is hence preferable that the storage battery 3 be prevented from discharging in an emergency. Accordingly, in the electric power supply system 10B in accordance with the present embodiment, the disaster-prevention-information-associated control unit 6d in the control device 6B controls the storage battery 3 to refrain from discharging to a level below the on-request minimum remaining stored charge level DRKE while a disaster-prevention warning is being issued.

Disaster-prevention warnings are, for example, issued by the Meteorological Agency against heavy rain, floods, stormy wind, storm surge, high waves, blizzard wind, heavy snow, and earthquakes. Because a power failure may occur in these situations, the disaster-prevention-information-associated control unit 6d controls the storage battery 3 to refrain from discharging. This control may be performed in response to all the disaster-prevention warnings and may be performed only while a predetermined warning is being issued. The disaster-prevention-information-associated control unit 6d preferably controls the storage battery 3 not only to refrain from discharging, but also to charge.

As described so far, in the electric power supply system 10B in accordance with the present embodiment, the disaster-prevention-information-associated control unit 6d in the control device 6B refrains from controlling the storage battery 3 (power storage device) to discharge to a level in the range of from the minimum remaining stored charge level KE to the on-request minimum remaining stored charge level DRKE while a disaster-prevention warning is being issued over the network NW (public communications network). This configuration enables the electric power supply system 10B to react preferentially to the situation in which a disaster-prevention warning is being issued rather than to an electric power supply request.

### General Description

The present invention, in aspect 1 thereof, is directed to an electric power supply system configured to communicate with a public communications network, the system including a power storage device (storage battery 3) configured to store electric power, the system being further configured to: control the power storage device (storage battery 3) to maintain a predetermined first remaining stored charge level (minimum remaining stored charge level KE); and control, in response to an electric power supply request received over the public communications network, the power storage device (storage battery 3) to discharge electric power in an electric power supply request period to a level not below a second remaining stored charge level (on-request minimum remaining stored charge level DRKE) that is below the first remaining stored charge level (minimum remaining stored charge level KE). The second remaining stored charge level (on-request minimum remaining stored charge level DRKE) may be equal to 0% and may be larger than 0%.

This configuration, if, for example, a demand response (DR) to decrease consumption is received as an electric power supply request transmitted over a public communications network, can supply electric power by discharging the power storage device in an electric power supply request period to a level in a range of from the first remaining stored charge level to the second remaining stored charge level, to satisfy such a request.

Therefore, the configuration can provide an electric power supply system in which the power storage device discharges to a level below the predetermined first remaining stored charge level in response to an electric power supply request received over the public communications network.

In aspect 2 of the present invention, the electric power supply system is preferably configured such that while a disaster-prevention warning is being issued over the public communications network, the system refrains from controlling the power storage device (storage battery 3) to discharge to a level not below the second remaining stored charge level (on-request minimum remaining stored charge level DRKE).

Disaster-prevention warnings are often issued over the public communications network in an emergency when electric power may be needed, for example, in case of a power failure. It is hence preferable that the power storage device be prevented from discharging in an emergency. Accordingly, in an aspect of the present invention, the system refrains from controlling the power storage device to discharge to a level not below the second remaining stored charge level while a disaster-prevention warning is being issued over the public communications network. This configuration enables the system to react preferentially to the situation in which a disaster-prevention warning is being issued rather than to an electric power supply request.

In aspect 3 of the present invention, the electric power supply system is preferably configured such that the system stores a value for the first remaining stored charge level (minimum remaining stored charge level KE) and a value for the second remaining stored charge level (on-request minimum remaining stored charge level DRKE) and changes these stored values for the first and second remaining stored charge levels.

This configuration enables the values of the first remaining stored charge level and the second remaining stored charge level to be readily changed in accordance with a situation.

In aspect 4 of the present invention, the electric power supply system is preferably configured such that the system allows the changes to be made on an external device.

This configuration enables the values of the first and second remaining stored charge levels to be readily changed through external communications.

In aspect 5 of the present invention, the electric power supply system is preferably configured such that once the electric power supply request period is over, the system controls the power storage device (storage battery 3) to maintain the first remaining stored charge level (minimum remaining stored charge level KE).

This configuration can return the first remaining stored charge level of the power storage device to a normal state.

In aspect 6 of the present invention, the electric power supply system may be configured such that once the electric power supply request period is over, the system controls the power storage device (storage battery 3) to charge in a late-night electricity tariff period to maintain the first remaining stored charge level (minimum remaining stored charge level KE).

This configuration can return the first remaining stored charge level of the power storage device to a normal state by charging the power storage device in a late-night electricity tariff period. This in turn enables inexpensive charging of the power storage device with late-night electric power.

The present invention, in aspect 7 thereof, is directed to a method of controlling electric power supply, the method including: controlling a power storage device (storage battery 3) to maintain a predetermined first remaining stored charge level (minimum remaining stored charge level KE); and controlling, in response to an electric power supply request received over a public communications network, the power storage device (storage battery 3) to discharge electric power in an electric power supply request period to a level not below a second remaining stored charge level (on-request minimum remaining stored charge level DRKE) that is below the first remaining stored charge level (minimum remaining stored charge level KE).

This configuration can provide an electric power supply control method by which the power storage device discharges to a level below the predetermined first remaining stored charge level in response to an electric power supply request received over the public communications network.

In an aspect of the present invention described so far, the storage battery is controlled in such a manner as to keep the remaining charge level within a typically available range that is limited in advance to avoid over-discharging and overcharging. As an example, the remaining charge level of 0% does not indicate that the storage battery is over-discharged, but refers to a minimum remaining stored charge level in a typically available range.

The present invention is not limited to the description of the embodiments above and may be altered within the scope of the claims. Embodiments based on a proper combination of technical means disclosed in different embodiments are encompassed in the technical scope of the present invention. Furthermore, a new technological feature may be created by combining different technological means disclosed in the embodiments.

### REFERENCE SIGNS LIST

1 Solar Cell Module
2 Power Conditioner
3 Storage Battery
4 Power Distribution Board
5 Smart Meter
6A, 6B Control Device
6a Minimum Remaining Stored Charge Level Control Unit
6b On-request Minimum Remaining Stored Charge Level Control Unit
6c Memory Unit
6d Disaster-prevention-information-associated Control Unit
7 Communications Unit
8 Operation Unit
10A, 10B Electric Power Supply System
21 Power System Grid
22 HEMS Server
23 Aggregator Server
24 Meteorological Agency Server
31 Power Generation Company/Power Grid Operator
32 Aggregator
33 Electric Power Consumer
33a Electric Power Consumer's Home
33b Out-of-home Electric Power Consumer
KE Minimum Remaining Stored Charge Level (First Remaining Stored Charge Level)
DRKE On-request Minimum Remaining Stored Charge Level (Second Remaining Stored Charge Level)

What is claimed is:

1. An electric power supply system configured to communicate with a public communications network, the system comprising a power storage device configured to store electric power, the system being further configured to: control the power storage device to maintain a predetermined first remaining stored charge level; and control, in response to an electric power supply request received over the public communications network, the power storage device to discharge electric power in an electric power supply request period to a level not below a second remaining stored charge level that is below the first remaining stored charge level.

2. The electric power supply system according to claim 1, wherein while a disaster-prevention warning is being issued over the public communications network, the system refrains from controlling the power storage device to discharge to a level not below the second remaining stored charge level.

3. The electric power supply system according to claim 1, wherein the system stores a value for the first remaining stored charge level and a value for the second remaining stored charge level and changes these stored values for the first and second remaining stored charge levels.

4. The electric power supply system according to claim 3, wherein the system allows the changes to be made on an external device.

5. The electric power supply system according to claim 1, wherein once the electric power supply request period is over, the system controls the power storage device to maintain the first remaining stored charge level.

6. The electric power supply system according to claim 5, wherein once the electric power supply request period is over, the system controls the power storage device to charge in a late-night electricity tariff period to maintain the first remaining stored charge level.

7. A method of controlling electric power supply, the method comprising:
controlling a power storage device to maintain a predetermined first remaining stored charge level; and
controlling, in response to an electric power supply request received over a public communications network, the power storage device to discharge electric power in an electric power supply request period to a level not below a second remaining stored charge level that is below the first remaining stored charge level.
